(19) United States
(12) Patent Application Publication
(10) Pub. No.: US 2021/0300024 A1
(43) Pub. Date: Sep. 30, 2021

(54) FLUID EJECTION DIE INCLUDING NOZZLE IDENTIFICATION

(71) Applicant: HEWLETT-PACKARD DEVELOPMENT COMPANY, L.P., Spring, TX (US)

(72) Inventor: Scott A Linn, Corvallis, OR (US)

(73) Assignee: HEWLETT-PACKARD DEVELOPMENT COMPANY, L.P., Spring, TX (US)

(21) Appl. No.: 16/343,814

(22) PCT Filed: Jan. 31, 2017
(86) PCT No.: PCT/US2017/015820

§ 371 Date: Apr. 22, 2019

(51) Int. Cl. B41J 2/045

(52) U.S. Cl. CPC B41J 2/0455; B41J 2/04565; B41J 2/0451

(57) ABSTRACT

Examples include a fluid ejection die. Examples comprise a set of nozzles, where each respective nozzle includes a respective fluid ejector. Examples further include respective identification logic for each nozzle, where the respective identification logic is connected to the respective nozzle and fluid ejector thereof. Furthermore, the identification logic for each nozzle of the set has a component characteristic that is different from other identification logic for nozzles of the set. Accordingly, each identification logic is to output a different actuation signal responsive to actuation of the fluid ejector.

### BACKGROUND

Fluid ejection dies may eject fluid drops via nozzles thereof. Nozzles may include fluid ejectors that may be actuated to thereby cause ejection of drops of fluid through nozzle orifices of the nozzles. Some example fluid ejection dies may be printheads, where the fluid ejected may correspond to ink.

### DRAWINGS

FIG. 1 is a block diagram that illustrates some components of an example fluid ejection die.

FIG. 2 is a block diagram that illustrates some components of an example fluid ejection die.

FIG. 3 is a block diagram that illustrates some components of an example fluid ejection die.

FIG. 4 is a block diagram that illustrates some components of an example fluid ejection die.

FIG. 5 is a block diagram that illustrates some components of an example fluid ejection die.

FIG. 6 is a flowchart that illustrates an example sequence of operations that may be performed by an example process.

FIG. 7 is a flowchart that illustrates an example sequence of operations that may be performed by an example process.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DESCRIPTION

Examples of fluid ejection dies may comprise a plurality of ejection nozzles that may be arranged in a set, where such plurality of nozzles may be referred to as a set of nozzles. A set of nozzles may be referred to as a “primitive” or a “firing primitive,” where a set of nozzles generally comprises a group of nozzles that have a unique actuation address. For example, a fluid ejection device may have four sets of nozzles, where each set of nozzles may comprise eight nozzles. In this example, each nozzle of the eight nozzle set may have a unique address. Moreover, nozzles may be arranged into sets of a given quantity, where a set may be referred to as a primitive. In some examples, electrical and fluidic constraints of a fluid ejection die may limit a single nozzle of each set of nozzles may be actuated for a given actuation event. For example, if nozzles of a fluid ejection die are arranged in four nozzle sets, for a given actuation event, one nozzle of each four nozzle set may be actuated.

In some examples, each nozzle may comprise a fluid chamber, a nozzle orifice, and a fluid ejector. A fluid ejector may include a piezoelectric membrane based actuator, a thermal resistor based actuator, an electrostatic membrane actuator, a mechanical/impact driven membrane actuator, a magneto-strictive drive actuator, or other such elements that may cause displacement of fluid responsive to electrical actuation. Furthermore, example fluid ejection dies may comprise, for each nozzle of the fluid ejection die, nozzle identification logic disposed proximate to the nozzle, which may be referred to as identification logic herein. Moreover, the identification logic for each respective nozzle may be connected to the respective nozzle and/or the fluid ejector thereof. For a set of nozzles, each respective identification logic for the nozzles of the set may have at least one different component characteristic. For example, if the identification logic comprises a switch (such as a transistor), the component characteristic that may be different for each identification logic may be a channel length, a channel width, a channel depth, etc. If the identification logic comprises a resistor, the component characteristic may be a resistance of each resistor for the identification logic of nozzles of a set.

In such examples, for a set of nozzles, an actuation signal transmitted through a respective nozzle and the connected identification logic may vary from other nozzles and identification logic of the set based on the component characteristic difference of each identification logic. In some examples, the actuation signal may be described as being transmitted through the nozzle, and in other examples the actuation signal may be described as being transmitted through the fluid ejector thereof. Therefore, in such examples, each nozzle (and a fluid ejector thereof) may be connected to a respective identification logic, and the identification logic may be connected to an identification output. When a respective nozzle is actuated, the actuation signal may be transmitted through the connected identification logic, and the actuation signal may be sensed at the identification output. Since each identification logic of the nozzles of a set may have a different component characteristic, it will be appreciated that the sensed actuation signal at the identification output may vary based at least in part on the nozzle and identification logic through which the actuation signal was transmitted.

In some fluid ejection devices and fluid ejection dies thereof, address data may be input to ejection logic, where the address data indicates the nozzle to eject fluid for a given ejection event. Based on the address data, the ejection logic generates ejection signals for nozzles to be ejected (as indicated by the address data). However, if any trace or logic in the address data to ejection signal path includes a defect (such as a shorted trace), a nozzle indicated to be ejected by the address data (e.g., the expected nozzle) may not eject. In some situations, a different nozzle of the set may eject. In addition, in some examples, received address data may not correspond to the fluid ejection die or a fluid ejection device in which the die may be implemented. In such examples, received data may cause incorrect ejection. Therefore, examples disclosed herein may facilitate identification of a respective nozzle that has been actuated. Furthermore, examples may compare the respective nozzle that was actuated (as determined based on sensing the actuation signal output at the Identification output) and the expected nozzle (as indicated in the address data) to determine whether the respective nozzle that was actuated is the expected nozzle.

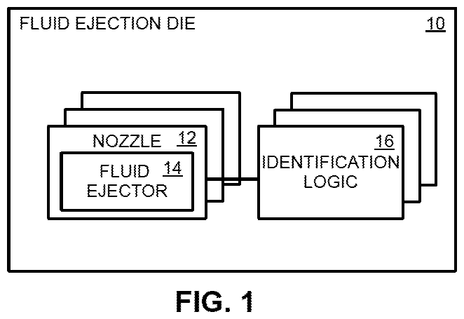

Turning now to the figures, and particularly to FIG. 1, this figure provides a block diagram that illustrates some components of an example fluid ejection die 10. As shown, the fluid ejection die may comprise a plurality of nozzles 12, where each nozzle 12 may include a respective fluid ejector 14. Each nozzle 12 (and fluid ejector 14 thereof) may be connected to a respective identification logic 16. In these examples, the nozzles 12 may be arranged into sets. The identification logic 16 of each nozzle 12 of a respective set of nozzles 16 may have at least one component characteristic that is different from the other identification logic 16 of the nozzles 12 of the set. Accordingly, it will be appreciated that, for a set of nozzles 12, a signal transmitted through each nozzle 12 of the set and the identification logic 16 connected to each nozzle 12 may exhibit different signal characteristics, such that the actuation signal sensed at an output may be a different signal depending on the nozzle and identification logic through which it was transmitted. For example, an output current or voltage of the actuation signal may be different based on the nozzle 12 and connected identification logic 16 through which the signal was transmitted.

While in FIG. 1, the fluid ejection die 10 is illustrated as including a particular number of nozzles, it will be appreciated that the quantity of elements included in FIG. 1 is merely for illustrative purposes. Examples similar to the example of FIG. 1 may comprise a larger quantity of nozzles and identification logic connected thereto.

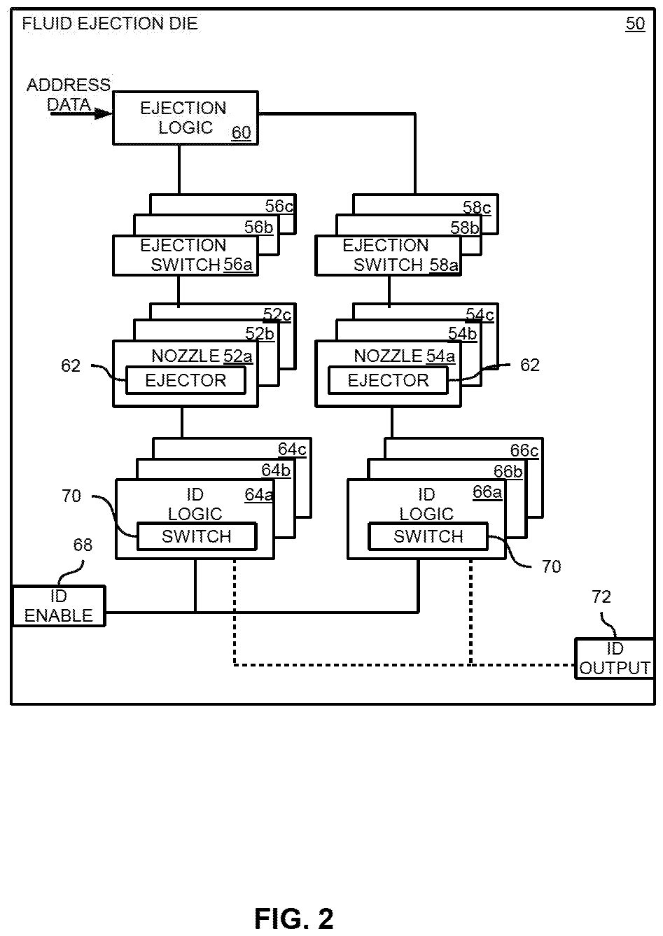

FIG. 2 provides a block diagram that illustrates some components of an example fluid ejection die 50. In this example, the fluid ejection die 50 comprises a first set of nozzles 52a-c and a second set of nozzles 54a-c. For each nozzle 52a-c, 54a-c, the fluid ejection die comprises a respective ejection switch 56a-c, 58a-c. In examples similar to the example of FIG. 2, address data may be communicated to ejection logic 60. The address data may indicate nozzles of the fluid ejection die to be actuated for an actuation event. Based on the address data, the ejection logic 60 may generate actuation signals to cause actuation of fluid ejectors 62 of the indicated nozzles 52a-c, 54a-c.

However, as discussed previously, the ejection logic 60 and/or the connections from the ejection logic to the ejection switches 56a-c, 58a-c, and/or the connections from the ejection switches 56a-c, 58a-c to the nozzles 52a-c, 54a-c may cause actuation of a nozzle 52a-c, 54a-c not indicated in the address data if there is a defect, or if the address data does not correspond to the fluid ejection die.

Therefore, as discussed previously, the fluid ejection die 50 may further comprise identification logic 64a-c, 66a-c connected to each nozzle 52a-c, 54a-c. The identification logic 64a-c, 66a-c for each nozzle of a set 52a-c, 54a-c may have at least one component characteristic that is different from the other identification logic 64a-c, 66a-c. For example, for the first set of nozzles 52a-c, the respective identification logic 64a-c connected to each nozzle 52a-c may have at least one component characteristic difference. Continuing the example, the first set of nozzles 52a-c includes a first nozzle 52a, a second nozzle 52b, and a third nozzle 52c. The first nozzle 52a is connected to a first identification logic 64a; the second nozzle 52b is connected to a second identification logic 64b; and the third nozzle 52c is connected to a third identification logic 64c.

According to some examples, an identification enable input 68 may be electrically actuated (i.e., power may be applied to the identification enable input 68) such that a switch 70 of each identification logic 64a-c, 66a-c may facilitate transmission of a signal from each nozzle 52a-c, 54a-c through each identification logic 64a-64c, 66a-66c to an identification output 72. Therefore, when the identification enable input is electrically actuated, and a respective nozzle 52a-c, 64a-c is actuated, the actuation signal may pass through the respective identification logic 64a-c, 66a-c, to the identification output 72. Based on the signal characteristics of the actuation signal at the identification output, the respective nozzle 52a-c, 54a-c that was actuated may be determined.

To further illustrate by way of example and referring to the above example, the switch 70 of each identification logic 64a-64c connected to the first set of nozzles 52a-c may have a different component characteristic. For example, each switch 70 may be a transistor, and the different component characteristic of each identification logic 64a-c may be a channel length of the transistor. In this example, the first identification logic 64a may have a channel length of a first length; the second identification logic 64b may have a channel length of a second length; and the third identification logic 64c may have a channel length of a third length. As discussed, the first length, second length, and third length are different. Accordingly, an actuation signal transmitted through the first nozzle 52a and first identification logic 64a would be different than an actuation signal transmitted through the second nozzle 52b/second identification logic 64b and the third nozzle 52c/third identification logic 64c. For example, a signal characteristic of the actuation signal that may differ may be a current or a voltage. While at least one component characteristic is different for each respective identification logic for nozzles of a set of nozzles, it may be appreciated that the component characteristics may not be different for identification logic connected to other sets of nozzles. For example, the first identification logic 64a for the first nozzle 52a of the first set 52a-c may have the same component characteristics as a first identification logic 66a for a first nozzle 54a of the second set of nozzles 54a-c. In some examples, that the identification components for a first set of nozzles may be arranged with component characteristics that are similar to identification components for a second set of nozzles.

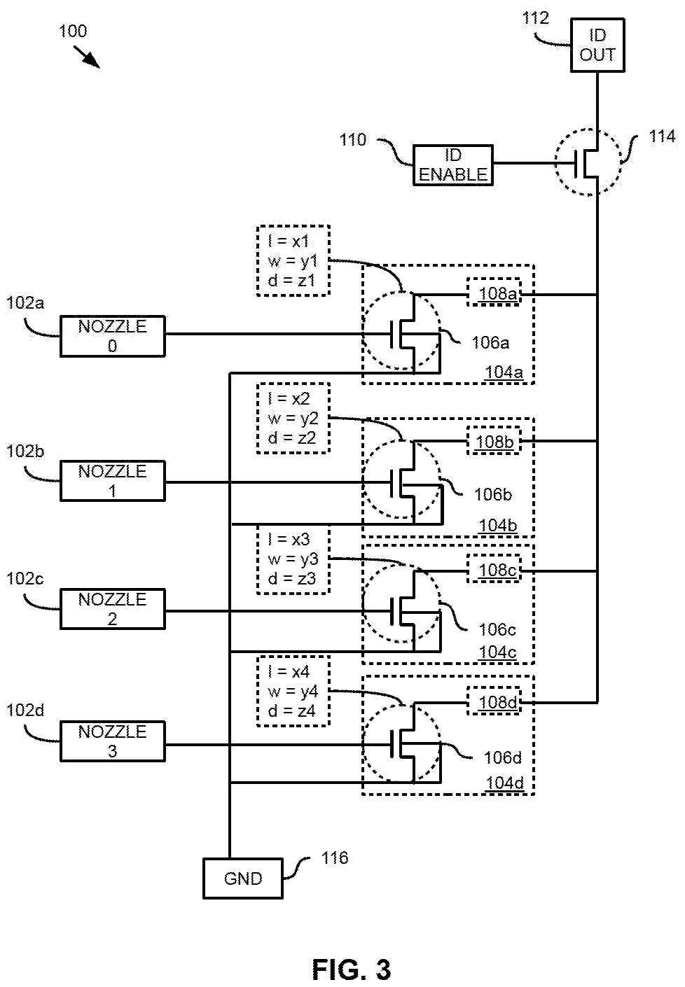

FIG. 3 provides a block diagram that illustrates some components of an example fluid ejection die 100. In this example, each nozzle 102a-d of a set of nozzles (also labeled ‘NOZZLE 0’, ‘NOZZLE 1’, ‘NOZZLE 2’, and NOZZLE 3′) is connected to respective identification logic 104a-d disposed proximate the respective nozzle 102a-d. As shown, respective identification logic 104a-d includes a transistor 106a-d. Furthermore it will be noted that component characteristics of each transistor 106a-d of each identification logic 104a-d are provided.

In this example, A first nozzle 102a of the nozzle set may be connected to a first identification logic 104a including a first transistor 106a having a channel length of ‘x1’, a channel width of ‘y1’, and a channel depth of ‘z1’. A second nozzle 102b of the nozzle set may be connected to a second identification logic 104b including a second transistor 106b having a channel length of ‘x2’, a channel width of ‘y2’, and a channel depth of ‘z2’. A third nozzle 102c of the nozzle set may be connected to a third identification logic 104c including a third transistor 106c having a channel length of ‘x3’, a channel width of ‘y3’, and a channel depth of ‘z3’. A fourth nozzle 102d of the nozzle set may be connected to a fourth identification logic 104d including a fourth transistor 106d having a channel length of ‘x4’, a channel width of ‘y4’, and a channel depth of ‘z4’. In some examples, at least one of the channel length, channel width, and channel depth for each transistor 106a-d is different from the other transistors 106a-d. For example, the second transistor 106b may have a channel length approximately 20% greater than a channel length of the first transistor 106a; the third transistor 106c may have a channel length approximately 20% greater than the channel length of the second transistor 106b; and the fourth transistor 106d may have a channel length that is 20% greater than the channel length of the third transistor 106c. In another example, some combination of channel length, channel width, and channel depth may be different for each transistor 106a-d. Other examples may include various other arrangements.

In addition, each respective identification logic 106a-d may include an additional component 108a-d, such as a resistor, capacitor, memristor, EPROM storage element, EEPROM storage element, etc. In examples in which identification logic 104a-d includes an additional component, it may be appreciated that a component characteristic of the additional component may be different for each identification logic 104a-d connected to a nozzle 102a-d of a set of nozzles. For example, if the additional component 108a-d of each respective identification logic 104a-d is a resistor, the different component characteristic for each respective identification logic may be a resistance value for each resistor.

As shown in FIG. 3, the identification logic 104a-d for each nozzle 102a-d may be connected to an identification enable input 110 and an identification output 112 via a transistor 114 (or other such switch component). Furthermore, each nozzle 102a-d and the respective identification logic 104a-d connected to each nozzle 102a-d may be connected to an electrical ground 116. Accordingly, it will be appreciated that, when the identification enable input 110 is not electrically actuated—i.e., when the transistor 114 is not electrically actuated such that the identification logic 104a-d may not transmit an actuation signal of a respective nozzle 102a-d therethrough, actuation signals may be transmitted to the electrical ground 116. In turn, when the identification input 110 is electrically actuated, the respective identification logic 104a-d connected to each respective nozzle 102a may transmit an actuation signal of a respective nozzle 102a-d through the respective identification logic 104a-d to the identification output 112 such that the actuation signal may be sensed at the identification output 112.

While the example shown in FIG. 3 illustrates a set of nozzles comprising four nozzles, it may be appreciated that other examples are not so limited. In other examples, eight nozzles, twelve nozzles, sixteen nozzles, or any other number of nozzles may be arranged in a given set of nozzles. As mentioned previously, the quantity of nozzles per nozzle set may be constrained by device limitations and/or requirements, such as power limitations, fluidic limitations, operating speed requirements, etc. Accordingly, examples contemplated by the description may comprise nozzles arranged into sets of various number.

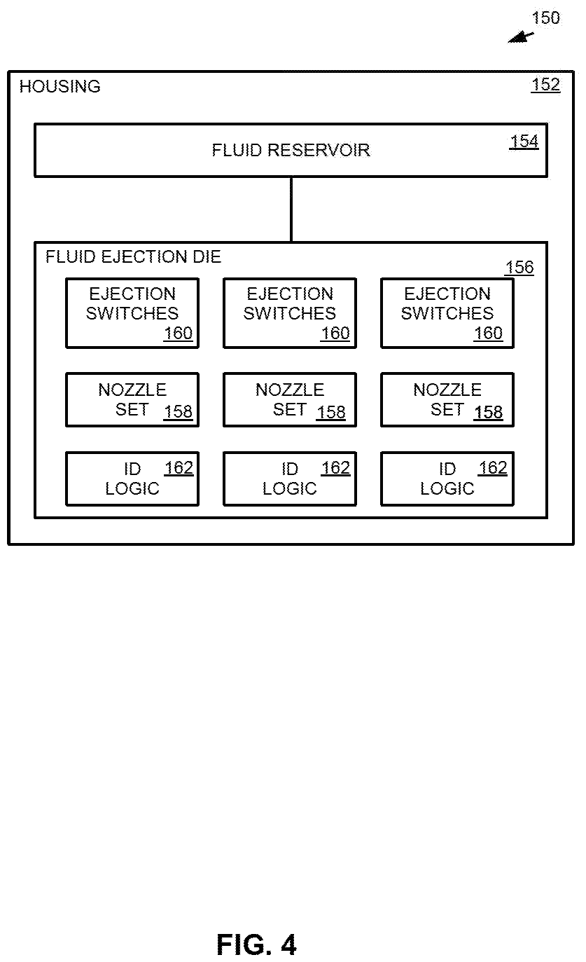

FIG. 4 provides a block diagram that illustrates some components of an example fluid ejection device 150. The fluid ejection device 150 comprises a housing 152, which may also be referred to as a cartridge or body. Within the housing 152, the fluid ejection device 152 may comprise a fluid reservoir 154 to store a fluid. It will be appreciated that in some examples the fluid reservoir 154 may correspond to a chamber formed in a portion of the housing 152, and in other examples, the fluid reservoir 154 may comprise a membrane (such as a fluid bag) or a volume defined by surfaces of a solid portions. The fluid reservoir 154 is fluidly connected to a fluid ejection die 156 similar to the other example fluid ejection dies described herein. In particular, the fluid ejection die 156 may comprise nozzle sets 158, ejection switches 160, and identification logic 162 as described herein. In some examples of fluid ejection devices similar to the example of FIG. 4, the fluid ejection die 156 may be a printhead that may eject ink, where the ink may be stored in the fluid reservoir 152. In these examples, the fluid ejection device may be referred to as a printing cartridge.

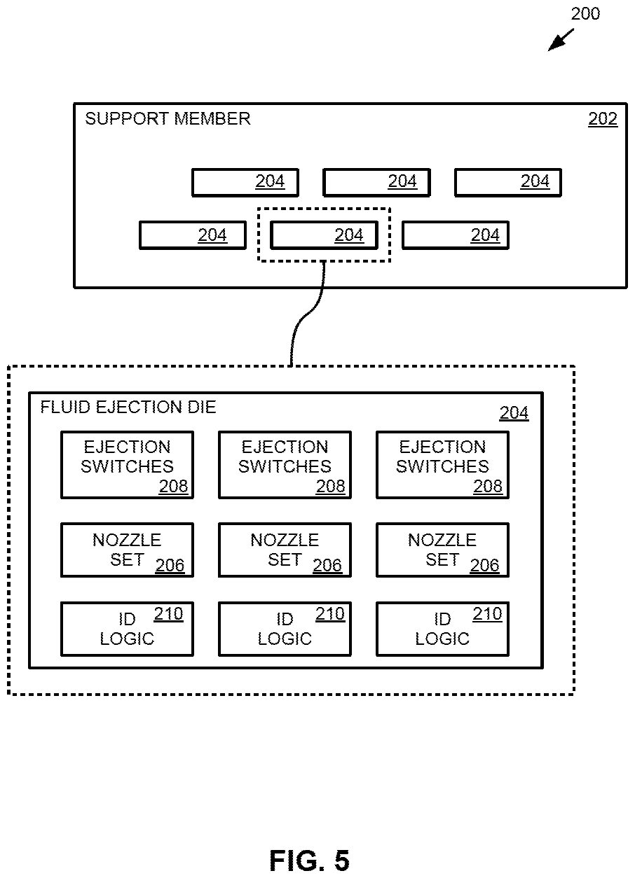

FIG. 5 provides a block diagram that illustrates some components of an example fluid ejection device 200. In this example, the fluid ejection device 200 includes a support member 202, where the support member 202 is coupled with a plurality of fluid ejection dies 204. In this example, the fluid ejection dies 204 are arranged generally end-to-end along a width of the support member 202 in a staggered manner. As shown in the detail view included in FIG. 5, each fluid ejection die 204 may be similar to other example fluid ejection dies described herein. In particular, each fluid ejection die may comprise nozzle sets 206, ejection switches 208 for each nozzle of each nozzle set 206, and respective identification logic 210 for each nozzle of each nozzle set 206 as described herein.

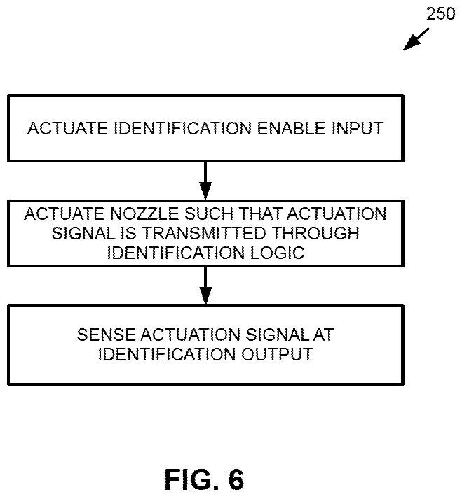

FIG. 6 provides a flowchart 250 that illustrates an example sequence of operations that may be performed by an example process. As discussed in previous examples, an identification enable input may be electrically actuated (block 252). A respective nozzle may be actuated such that the actuation signal may be transmitted through identification logic connected to the actuated nozzle (block 254). The actuation signal may be transmitted through the connected identification logic to the identification output, where the actuation signal may be sensed (block 256).

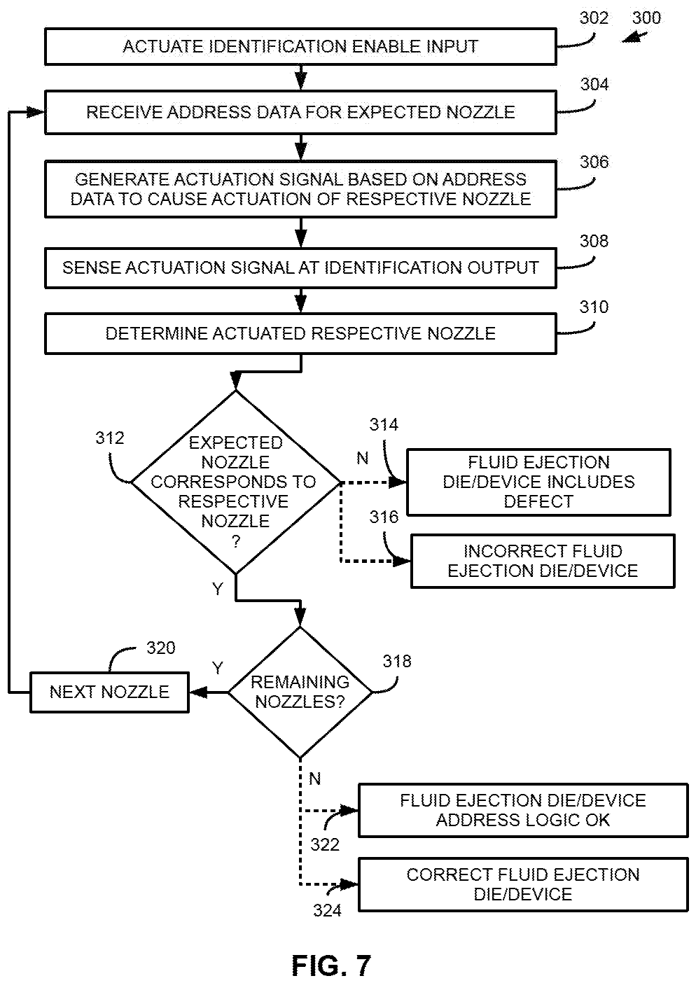

FIG. 7 provides a flowchart 300 that illustrates an example sequence of operations that may be performed by an example process for a fluid ejection die. In this example, an identification enable input may be electrically actuated (block 302). Ejection logic of the fluid ejection die may receive address data that indicates a nozzle to be actuated, which may be referred to as an expected nozzle (block 304). The ejection logic may generate an actuation signal based on the address data to thereby cause actuation of a respective nozzle (block 306). Since the identification enable input is actuated, the actuation signal may be transmitted through identification logic connected to the respective nozzle to the identification output such that the actuation signal may be sensed at the identification output (block 308). A device connected to the fluid ejection die (such as a test device or a fluid ejection system) may determine the respective nozzle that was actuated based on the sensed actuation signal at the identification output (block 310).

The connected device may determine whether the expected nozzle corresponds to the respective nozzle (block 312). In other words, the device may determine whether the nozzle indicated in the address data corresponds to the nozzle that was determined to have been actuated. In response to determining that the expected nozzle does not correspond to the respective nozzle (“N” branch of block 312), the device may determine that the fluid ejection die includes a defect (block 314). For example, if the device is a testing device, and the expected nozzle does not correspond to the respective actuated nozzle, the testing device may determine that the fluid ejection die includes a defect. As discussed above, a defect may occur in ejection logic, connective traces between elements on a fluid ejection die, etc.

In other examples, in response to determining that the expected nozzle does not correspond to the respective nozzle (“N” branch of block 312), the device may determine that the fluid ejection die is incorrect for the device (block 316). For example, if the device is a fluid ejection system, such as a printer, if the actuated respective nozzle does not correspond to the expected nozzle, the fluid ejection die may not be correctly arranged to accurately eject fluid for address data received from the fluid ejection system.

In response to determining that the expected nozzle corresponds to the actuated respective nozzle (“Y” branch of block 312), the device may determine if additional nozzles remain to be identified/evaluated (block 318). If additional nozzles remain to be evaluated (“Y” branch of block 318), the device may proceed with evaluating the next nozzle (block 320) by repeating at least some of the operations described in blocks 304-316 with regard to the next nozzle.

If the device is a testing device, a some or all nozzles of the fluid ejection die may be actuated and the results may be analyzed to determine that the fluid ejection die does not include a defect, i.e., that the fluid ejection die or fluid ejection device upon which the fluid ejection die is implemented is determined to operate as expected. In such examples, a fluid ejection die and/or fluid ejection device in which the die is implemented that includes nozzles in which address data causes actuation of the expected nozzle, the die/device may be determined to be ‘OK’ (block 322). If the device is a fluid ejection system (such as a printer), and the address data causes actuation of the expected nozzle, the device may determine that the fluid ejection die/device is correct for the device (block 324).

Accordingly, examples provided herein may provide a fluid ejection die including nozzle identification logic connected to each nozzle. When enabled, the nozzle identification logic may transmit an actuation signal from the connected nozzle therethrough to an identification output. Since the nozzle identification logic for each nozzle of a set of nozzles has a different component characteristic, the actuation signal output at the identification output may vary in a manner corresponding to the component characteristic difference. Therefore, for a given set of nozzle, a respective nozzle of the set that was actuated may be identified. In some examples, comparison of the respective nozzle that was actuated and the nozzle that was expected to be actuated based on address data may facilitate a determination of whether the ejection logic and electrical connections of the set of nozzles is correct. In other examples, the comparison may facilitate determining whether the fluid ejection die is correctly arranged for a given device in which the die is implemented.

The preceding description has been presented to illustrate and describe examples of the principles described. This description is not intended to be exhaustive or to limit these principles to any precise form disclosed. Many modifications and variations are possible in light of the description. In addition, while various examples are described herein, elements and/or combinations of elements may be combined and/or removed for various examples contemplated hereby. For example, the example operations provided herein in the flowcharts of FIGS. 6-7 may be performed sequentially, concurrently, or In a different order. Moreover, some example operations of the flowcharts may be added to other flowcharts, and/or some example operations may be removed from flowcharts. In addition, the components illustrated in the examples of FIGS. 1-5 may be added and/or removed from any of the other figures. Therefore, the foregoing examples provided in the figures and described herein should not be construed as limiting of the scope of the disclosure, which is defined in the Claims.

1. A fluid ejection die comprising:
a set of nozzles, each respective nozzle of the set of nozzles comprising a respective fluid ejector; and
respective identification logic for each respective nozzle of the set, each respective identification logic connected to the respective nozzle, and each respective identification logic having at least one component characteristic different from other respective identification logic such that each respective identification logic is to output a different actuation signal responsive to actuation of the respective fluid ejector.

2. The fluid ejection die of claim 1, further comprising:
an identification output connected to each respective identification logic;
for each respective nozzle, a respective ejection switch connected to respective fluid ejector thereof, the respective ejection switch to selectively transmit an actuation signal to the respective fluid ejector,
wherein each respective identification logic comprises a switch to selectively transmit the actuation signal for the respective fluid ejector through the respective identification logic to the identification output.

3. The fluid ejection die of claim 2, further comprising:
an identification enable input connected to the switch of each respective identification logic, wherein the switch of each respective identification logic is to transmit the actuation signal for the respective fluid ejector through the identification logic to the identification output when the identification enable input is electrically actuated.

4. The fluid ejection die of claim 1, wherein each respective identification logic comprises at least a transistor, and the at least one component characteristic of each respective identification logic comprises at least one of a channel width of the transistor, a channel length of the transistor, a channel depth of the transistor, or any combination thereof.

5. The fluid ejection die of claim 1, further comprising:
a second set of nozzles, each respective nozzle of the second set of nozzles comprising a respective fluid ejector; and
respective identification logic for each respective nozzle of the second set connected to the identification output, each respective identification logic for the second set of nozzles connected to a respective nozzle of the second set of nozzles, and each respective identification logic for of the second set of nozzles having at least one component characteristic different from other respective identification logic for the second set of nozzles such that each respective identification logic for the second set of nozzles is to output a different actuation signal responsive to actuation of the respective fluid ejector of the second set of nozzles.

6. The fluid ejection die of claim 1, further comprising:
ejection logic connected to the respective fluid ejectors of the set of nozzles, the ejection logic to transmit actuation signals to the respective fluid ejectors of the set of nozzles.

7. The fluid ejection die of claim 1, wherein each respective identification component comprises one of a resistor, a transistor, or a capacitor.

8. A process for a fluid ejection die including a set of nozzles, the process comprising:
actuating an identification enable input to thereby enable respective identification logic for each nozzle of the set, each identification logic having a different component characteristic than the other identification components;
actuating a respective nozzle of the set to thereby transmit an actuation signal through the respective identification logic for the respective nozzle; and
sensing the actuation signal at an identification output, wherein the actuation signal at the identification output varies based at least in part on the component characteristic of the respective identification logic for the respective nozzle.

9. The process of claim 8, further comprising:
receiving address data corresponding to an expected nozzle;
generating an actuation signal based on the address data to thereby cause actuation of the respective nozzle.

10. The process of claim 9, further comprising:
determining whether the expected nozzle corresponds to the actuated respective nozzle based at least in part on the address data and the actuation signal sensed at the identification output.

11. The process of claim 10, further comprising:
in response to determining that the expected nozzle does not correspond to the actuated nozzle, determining that the fluid ejection die includes a defect.

12. A fluid ejection device comprising:
a fluid ejection die comprising a plurality of nozzles, the plurality of nozzles arranged into sets of nozzles;
for each respective nozzle of the plurality:
an ejection switch connected to the respective nozzle;
identification logic connected to the respective nozzle,
wherein the identification logic of each respective nozzle has at least one component characteristic different from other identification logic of the nozzles of the set of nozzles into which the respective nozzle is arranged.

13. The fluid ejection device of claim 12, further comprising:
a housing including a fluid reservoir to store a fluid, wherein the fluid ejection die is coupled to the housing and fluidly connected to the fluid reservoir.

14. The fluid ejection device of claim 12, wherein the fluid ejection die further comprises:
an identification enable input and an identification output connected to each identification logic;
ejection logic to receive address data and selectively generate actuation signals for the nozzles of the plurality based at least in part on the address data,
wherein the identification logic of each respective nozzle is to transmit an actuation signal for the respective nozzle to the identification output when the identification enable input is electrically actuated.

15. The fluid ejection device of claim 12, wherein the fluid ejection die is a first fluid ejection die of a plurality of fluid ejection dies, and the fluid ejection device further comprises:
a support member having a width along which the plurality of fluid ejection dies are arranged generally end-to-end.
